(19) United States
(12) Patent Application Publication
(10) Pub. No.: US 2014/0302914 A1
(43) Pub. Date: Oct. 9, 2014

(54) Computer-based Methods and Systems for Fantasy Sports Gaming

(71) Applicants: Bram Weinstein, Bloomfield, CT (US); Cory Dorfman, Gainesville, FL (US)

(72) Inventors: Bram Weinstein, Bloomfield, CT (US); Cory Dorfman, Gainesville, FL (US)

(21) Appl. No.: 14/200,276

(22) Filed: Mar. 7, 2014

Related U.S. Application Data
(60) Provisional application No. 61/799,600, filed on Mar. 15, 2013.

(51) Int. Cl. A63F 13/00

(52) U.S. Cl. CPC A63F 13/00
USPC 463/25

(57) ABSTRACT

Systems, methods and computer program products used creating online or web or app based fantasy games and integrated betting systems.

### RELATED APPLICATION

This application claims priority to U.S. Provisional Application No. 61/799,600, filed Mar. 15, 2013, hereby incorporated by reference.

### TECHNICAL FIELD

The invention generally relates to systems, methods and computer program products used creating online or web or app based fantasy games and integrated betting systems.

### BACKGROUND

Several publications are referenced in this application. The cited references describe the state of the art to which this invention pertains and are hereby incorporated by reference, particularly the systems and methods set forth in the detailed description and figures of each reference.

Interactive electronic, online games and gambling systems and methods are well known and widely implemented and played by users around the world.

The fantasy (or Rotisserie) games typically involve customers/participants who construct unique sports teams based on drafting players from a variety of teams. The clients compete with virtual teams based on a point system that directly determines how the actual players perform in real world games. In some cases, these teams compete in a simulation to determine an outcome of an event not related to any real world event, but solely determined by a simulator.

### SUMMARY OF INVENTION

The invention relates to systems, methods and computer program products used creating online or web or app based fantasy games and integrated betting systems.

One aspect of the invention relates to methods and systems for conducting a fantasy game where users would compete against each other (“Open Competition”). The underlying goal of the game or competition is for the users to have a higher difference margin versus the “sports-lines” in the user's fantasy team lineup based on the real-word sporting event(s). That is, the users focus on building a fantasy team with individually selected team members who the user believes will beat the team member's expected playing metrics (e.g., the sports-lines).

Another aspect of the invention relates to methods and systems for conducting a fantasy game where users would compete against “the house” (e.g., “Vegas model”) rather than competing only against other users.

The foregoing has outlined some of the aspects of the present invention. These aspects should be construed as being merely illustrative of some of the more prominent features and applications of the invention. Many other beneficial results can be obtained by modifying the embodiments within the scope of the invention. Accordingly other objects and a full understanding of the invention may be had by referring to this summary of the invention, the detailed description describing the preferred embodiment in addition to the scope of the invention defined by the claims taken in conjunction with the accompanying drawings. The unique features characteristic of this invention and operation will be understood more easily with the description and drawings. It is to be understood that the drawings are for illustration and description but does not define the limits of the invention.

### DETAILED DESCRIPTION OF PREFERRED EMBODIMENTS

In the following description, for purposes of explanation, specific details are set forth in order to provide a thorough understanding of different aspects of the present invention. It will be evident, however, to one skilled in the art that the present invention as defined by the claims may include some or all of the features or embodiments herein described and may further include obvious modifications and equivalents of the features and concepts described herein.

### DEFINITIONS

“Sports lines”: The numbers assigned by the Linesmakers which can handicap one team or player and favors another or otherwise makes predictions relating to sporting events or predicts player performance during future sporting events.
“Linesmaker”—act as a market maker for sports wagers, most of which have a binary outcome: a team either wins or loses.
“Points”: Playing or performance metrics for players in sporting events.
“Sporting Event”—includes professional, college, national, Olympics and other events including competitive sports.
“Fantasy Game Period”—Daily, weekly, monthly, and seasonally depending on the sport.
“Fantasy Line”—a projected total for a single player that incorporates the opinions of a various fantasy experts.
“House user” or “the house”: a facility or system which houses, accommodates, implements, or manages gambling activities or fantasy games. For example, a casino or online game website.

The invention relates to systems or computer-based or application or website based methods for performing or conducting a fantasy game.

According to one aspect of the invention, users would compete against each other (“Open Competition”). The underlying goal of the game or competition is for the users to have a higher difference margin versus the “sports-lines” in the user's fantasy team lineup based on the real-word sporting event(s). That is, the users focus on building a fantasy team with individually selected team members who the user believes will beat the team member's expected playing metrics (e.g., the sports-lines). For example, if the professional football player Drew Brees is projected to have 25 fantasy points, but later in the real-world game achieves 33 points, the player selecting Brees would have a scoring margin of +8. Thus, according to this preferring embodiment, the game is about picking players who the users feel will have better games than the sports lines suggest. For example, in future weeks, it may make more sense to start the Buffalo Bills middling QB Ryan Fitzpatrick than the Pro Bowl QB Peyton Manning if the user believes Fitzpatrick will outperform relative to Manning in the specific game dates involved.

The Open Competition methods of the invention comprise varying preferred embodiments.

According to one embodiment, users would compete against each other in a league. Instead of a winner being determined by a house model or linesmaker, the user with the highest cumulative difference among the playing users would win that week. Also, this model eschews the utopian score by relying on you to select players that you believe will outperform their projections. As such, looking at quarterbacks, Peyton Manning is projected to score 25 points and Tom Brady is projected to score 15. However, you believe Brady's cumulative difference will be higher than Manning's, and thereby you insert Brady into your starting lineup. Players are selected either via a draft or a salary cap. There are a number of nuances we can employ for the procurement of players. For instance, perhaps you draft a new team each week and the league essentially resets after Monday Night Football. Or, like most standard leagues, the team you draft pre-season is your permanent team less trades, add/drops, etc. For example, in the 2013 NFL Season, User A and User B are in a league amongst our college fraternity brothers. User B plays User A in Week 1 and User B's cumulative difference is +3 whereas User A's is +2.5. User B would win that week and being 1-0 going into Week 2.

According to another embodiment, the set-up is Rotisserie-style. For example, looking back to the prior example of User A and User B being in the same league, we no longer use a binary system of wins and losses. In essence, after Week 1, User A's record isn't 0-1 but rather +2.5. In Week 2, if User A's cumulative difference is +3, his aggregate score going into Week 3 is +5.5. With a score of +5.5, User A is in 3rd place in his league because his cumulative difference score ranks third amongst his league competitors.

Another embodiment relates to a computer-based method for conducting a fantasy game comprising:
receiving assignments of a plurality of players from a first user forming a first user fantasy team, each player having one or more predicted playing metrics;
receiving, by way of a computer, real-world playing metrics from one or more real-world competitive events including one or more real-world playing metrics from said plurality of players of said first user fantasy team;
calculating award points for said first user based on the cumulative differences between said one or more real-world playing metrics and said one or more predicted playing metrics; and
awarding said first player based said calculated award points.

Preferably, the first user competes against one or more other users and wherein the user with the highest calculated award points wins the fantasy game.

Preferably, the first user competes against a specified number of other users and wherein the user with the highest calculated award points wins the fantasy game.

According to preferred embodiments, awarding according to the fantasy game is performed after a predetermined timed interval. Preferably, the awarding is performed after a predetermined number of real-world events.

Preferably, the fantasy game lasts one day, one week, one month, one season or one year.

According to one version of Open Competition according to the invention (“Version 1”), one user would play against one user each “league week.” League week is generally seven days. NFL teams play once a week whereas the MLB, NBA, and NHL have multiple games during each league week. At the end of the league week, the user with the higher cumulative difference would be deemed the winner and awarded one “win.” The last two or three weeks of the respective season would be devoted to the fantasy playoffs where the top four to eight teams (based on team's winning percentage) in each league will compete and one will be eventually anointed as the “league winner.”

According to a second version (“Version 2”), one user would compete against all other users each league week. At the end of each league week, the said users cumulative difference will be added to their previous week's cumulative difference thus comprising one total “aggregate difference.” The standings hierarchy is derivative of the teams with the highest aggregate cumulative difference. In this model, there will be no playoff system and the team with the highest aggregate difference at the end of the league year will be deemed the league winner.

According to a third version (“Version 3”), users will utilize Version 1 as their regular-season scoring model and Version 2 as their playoff scoring model.

According to a fourth version (“Version 4”), users will utilize Version 2 as their regular-season scoring model and Version 1 as their playoff scoring model.

Preferably, the players are assigned salary information and a first user is allocated fantasy money for forming said first user fantasy team within specified salary caps.

Preferably, the players include a finite number of players.

According to preferred embodiments, the players are professional sports players, college players or Olympic players. Preferably, professional players selected from football, baseball, basketball, hockey, soccer, cricket, cycling, racing, tennis, or rugby. Preferably, the players are professional players selected from NFL, MLB, NHL, NBA, PGA, or MLS.

According to preferred embodiments, the players are baseball players and the one or more playing metrics including one or more metrics selected from the group consisting of: Hits, HR, RBI, SB, BA, AVG, SLG %, OPS, OB %, W, WHIP, K/9, TB and IBB.

According to preferred embodiments, the players are football players and the one or more playing metrics including one or more metrics selected from the group consisting of those listed in Table A below.

Another embodiment of the invention relates to a method of conducting a fantasy sports competition adapted to be played by a plurality of participants, comprising awarding a winner for said fantasy sports completion based on highest cumulative differences between one or more real-world playing metrics and one or more predicted playing metrics.

Another embodiment of the invention relates to methods of or systems for conducting a fantasy sports competition adapted to be played by a plurality of participants, each having a fantasy team, the method comprising awarding a winner for said fantasy sports competition based on highest cumulative differences between one or more real-world playing metrics of individual players on each fantasy team and one or more predicted playing metrics of said individual players on each fantasy team.

Yet another embodiment of the invention relates to methods of or systems for conducting a fantasy competition defined by a sequence of actual events comprising:

(a) enrolling users within said fantasy competition;
(b) creating fantasy teams for enrolled users in said fantasy competition by enabling users to select team players to create fantasy teams for said fantasy competition, said selected team players being assigned predicted performance values; and
(c) determining points utilized for awards based on actual performance values of said selected team players in said corresponding actual events, wherein point values are assigned based on the cumulative differences between the actual performance values of said selected team players and said predicted performance values of said selected team players.

Another embodiment of the invention relates to a system for conducting a fantasy competition comprising:
a computer system to conduct a fantasy competition defined by a sequence of actual events, said computer system including:
a join module to enroll users within said fantasy competition;
a draft module to create fantasy teams for enrolled users in said fantasy competition by enabling enrolled users to select team players to create fantasy teams for said fantasy competition, said selected team players being assigned predicted performance values; and
a points module to determine points utilized for awards based on corresponding actual events and actual performance values of said selected team players in those corresponding actual events, wherein said point are assigned based on the cumulative differences between the actual performance values and assigned performance values.

Preferably, the fantasy games according to the invention include a number of variables that pre-existing fantasy games do not account for or address, namely finding players who might have a comparative advantage in a certain week versus an absolute advantage throughout the season.

Preferably, wherein the first user competes against a house user and the user with the highest award points wins the fantasy game.

Another aspect of the invention relates to systems or methods where one or more users compete against “the house” (e.g, “Vegas model”). For example, according to the “vegas model”, each week (for football season) or game (for baseball, basketball, hockey, etc.), a user bets against the house “utopian” score. The utopian score is calculated by the highest projected totals for each fantasy position. In order to win, presumably “even money,” the user would have to +1 the house score.

One aspect of the invention relates to methods and systems for conducting a game comprising:
generating a house fantasy team including predicted highest scoring players for each fantasy team position for a specified playing period and aggregating the predicted scores for said predicted highest scoring players for said specified playing period thereby forming a utopian score;
receiving assignments of a plurality of players for each fantasy team position from a first user forming a first user fantasy team for said specified playing period;
receiving real-world player scores for said specified playing period;
calculating a real-world first user fantasy team score by aggregating the real-world scores for said plurality of players for said specified playing period; and
awarding said first user if said real-world first user fantasy team score is greater than said utopian score.

According to one preferred embodiment, the first user competes alongside one or more other users. Preferably, the user with the highest calculated award points wins the fantasy game. Preferably, the first user competes alongside a specified number of other users and wherein the user with the highest calculated award points wins the fantasy game.

Another aspect of the invention relates to systems and methods for conducting a game comprising:
generating a house fantasy team including predicted highest scoring players for each fantasy team position for a specified playing period and aggregating the predicted scores for said predicted highest scoring players for said specified playing period thereby forming a utopian score;
receiving assignments of a plurality of players for each fantasy team position from a first user forming a first user fantasy team for said specified playing period;
receiving real-world player scores for said specified playing period;
calculating a real-world house fantasy team score by aggregating the real-world scores for said predicted highest scoring players for said specified playing period; calculating a real-world first user fantasy team score by aggregating the real-world scores for said plurality of players for said specified playing period; and awarding said first user if said real-world first user fantasy team score is greater than said real-world house fantasy team score.

Accordingly, aspects of the invention include “Open Competition” and “Vegas” game methods and systems.

According to preferred embodiments, awarding according to the fantasy game is performed after a predetermined timed interval. Preferably, the awarding is performed after a predetermined number of real-world events.

Preferably, the fantasy game lasts one day, one week, one month, one season or one year.

Preferably, the players are assigned salary information and a user is allocated fantasy money for forming the user's fantasy team within specified salary caps.

Preferably, the players include a finite number of players.

According to preferred embodiments, the players are professional sports players, college players or Olympic players. Preferably, professional players selected from football, baseball, basketball, hockey, soccer, cricket, cycling, racing, tennis, or rugby. Preferably, the players are professional players selected from NFL, MLB, NHL, NBA, PGA, or MLS.

According to preferred embodiments, the players are baseball players and the one or more playing metrics including one or more metrics selected from the group consisting of: Hits, HR, RBI, SB, BA, AVG, SLG %, OPS, OB %, W, WHIP, K/9, TB and IBB.

According to preferred embodiments, the players are football players and the one or more playing metrics including one or more metrics selected from the group consisting of those listed in Table A.

According to preferred embodiments, users would either have an appropriated amount of funds (salary-cap) to create a fantasy team or would draft a finite amount of players (e.g. in Fantasy Football, a standardized lineup 1 QB, 2 RB, 3 WR, 1 TE, 1 K, 1 D, 6 Bench). For Vegas game model, the salary cap is essentially the utopian Vegas score. For example, on a random Monday, it may be deduced that the top MLB utopian lineup is 145 points. Ergo, according to preferred embodiments, a user's salary allotment cannot go over 145 projected points because it is impossible (cannot go over the utopian amount). In short, according to preferred embodiments, a user can procure any players as long as they fit into the user's lineup with their positions.

The fantasy games according to the invention can be applied to the NBA, MLB, NFL, PGA, etc.

For each and every sporting event, individual players (athletes) would preferably designated their own fantasy line.

Games could include NFL, MLB, NHL, NBA, PGA, etc.

The methods and system of the invention include a variety of method for users to generate their fantasy team lineup. For example, procuring players to fill out one's lineup according to preferred embodiments, there would be three possible scenarios:
A.) “Draft”
B.) “Appropriation of funds/Salary Cap”
C.) “Free for all pick'em”: this would be applicable to the Vegas embodiments, Users would fill out a standard fantasy lineup and wager their players would score higher than Vegas high prediction for the day.

In options A+B, there would be a finite amount of users/players in a league. Again, being risk-averse might entail the league lasting at least two weeks.

In option C the user would be merely playing against the house. For example, a user can walk into the Mirage and bet the Miami Heat spread versus the New York Knicks. Instead, according to the invention, the user would have the same ability to construct a fantasy roster that that the user thinks would beat the house score.

Preferably, pursuant to the cumulative difference games according to preferred embodiments, the underlying purpose is to have your players with a higher differential versus their predicted performance than your opponent. You would just have to pick “surprise” players that you believe will far exceed their expectations. This creates an egalitarian platform where the Miami Dolphins backup running back might be as important and picked by a user over Peyton Manning.

Other embodiments of the invention relate to the above-described methods adapted or configured to incorporate the theme or concept of “confidence points”. For example, with respect to fantasy line(s), “confidence points” would be used to give weight to each line in a given week. Succinctly, a fantasy football starting lineup generally consists of 10-12 NFL players. (i.e. 1 QB, 2 RB, 3 WR, 1 TE, 1 WR/RB/TE, 1 K, 1 D). Confidence point selections will be paired with their respective fantasy line to create a novel game (see Example 5 below). The term “confidence Points” can be described as the higher the confidence you assign to a fantasy line, the more points you will earn if you have selected the winning team. Each line will have a different confidence value assigned to it, such as, ranging from 1 (least confident) to 10 (most confident). For example, if you assign 9 points to Calvin Johnson scoring 15 fantasy points vs. the Vikings (because you are very confident in him exceeding that total) and he actually totals 17 points, your entry will receive 9 points for the correct selection. If Johnson scores under 15 fantasy points, you will receive 0 confidence points.

Another aspect of the invention relates to a computer based system capable of performing the game methods of the invention comprising a processor coupled to a memory, the memory having computer readable code, which when executed by the processor causes the computer system to perform the methods described above.

According to preferred embodiments, the methods are performed using an algorithmic logic engine.

Existing systems and methods can be modified and used to implement the current invention. See, US 201200115585 to Goldman et al.; US20120264503 to Lisen, U.S. Pat. No. 8,360,835 to Strause et al., U.S. Pat. No. 8,292,725 to Wikander; U.S. Pat. No. 8,177,644 to Andersen, et al., US20100279774 Braig et al., US 20130018492 to Trdinich, et al., US 20130005422 to Callery et al., US20060237905 to Mitenberger, et al, hereby incorporated by reference, specifically the computer based methods and systems described in the detailed description of each document and each of the figures and figure description.

### EXAMPLES

### Example 1

### Vegas Style NFL Fantasy Game

On Week 1 of the 2013 NFL season, a sports lines maker projects that that the highest-scoring “utopian” lineup for the line maker's fantasy team would yield 112 points. This number would be computed by adding the projected lines of the highest rated players for line maker's designated fantasy team positions (e.g., 1 QB, 2 RB, 3 WR, 1 TE, 1 K, and 1 D).

Accordingly, for a user to beat the sport-line generated utopian score, the user would need to score greater than 112 points (e.g. +1 over the utopian score).

### Example 2

### Vegas Style Professional Baseball Fantasy Game

Similar to Example 1, in a rotisserie-style Vegas game applied to professional baseball sporting events, a user would have to outscore the sports-line on a number of metrics (i.e. Hits, HR, AVG, SLG %, OPS, OB %, W, WHIP, K/9). The fantasy game period could last a day, a week, or throughout the duration of the 182-game baseball season.

### Example 3

A user challenges Vegas to their Week 3 Fantasy Challenge. Each week, a fantasy linesmaker would prognosticate the highest scoring players from each position. The aggregate scores from these positions (1 QB, 2 RB, 3 WR, 1 TE, 1 K, 1 D) would comprise the utopian score of the week. Down below, Tom Brady is projected to be the highest rated QB for Week 3, thereby his 35 projected points are included in the house utopian score. Additionally, Adrian Peterson and Frank Gore are projected to be the two highest scoring RB's and their projected total's are also included in the utopian score. This will subsequently done for the 3 WR, 1 TE, 1 K, and 1 D

### Example 4

A user walks into the Bellagio on Wednesday, October 13th. He decides to challenge the house in their weekly fantasy challenge. The user has the option of picking any player from every game (TR-M) to fill out his lineup prior to the first game played every week. Otherwise, the pool of players becomes more narrow and dilutes this as less of a game of skill and more of a game of gambling.

### Example 5

### Confidence Points

### (Sep. 14, 2014) Week 2 of an NFL Season-User's Team

(10) QB—Tom Brady (10)

(9) RB—Adrian Peterson (12)

(8) RB—Lamar Miller (11)

(7) WR—Mike Wallace (13)

(6) WR—Marques Colston (12)

(5) WR—Eric Decker (12)

(4) TE—Antonio Gates (8)

(3) WR/TE/RB—Jimmy Graham (15)

(2) K-Nick Folk (7)

(1) D: Baltimore Ravens (14)

The numbers on the left indicate confidence point selections whereas the numbers on the right are the players fantasy line. For instance, in Week 2 of the NFL season, Tom Brady is projected to score at least 10 fantasy points. Out of all the players on the roster above, I am the MOST confident Tom Brady will achieve at or above his fantasy line designation. Therefore, I ascribed 10 confidence points to him. If Tom scores under his fantasy line projection (10)—I do not receive my (10) confidence points. Whereas, if Brady had a scintillating fantasy day and had well over 10 fantasy points, I would thereby gain the (10) confidence points.

TABLE A
Fantasy Baseball:

| | |
|---|---|
| GP | Games Played |
| GS | Games Started |
| AVG | Batting Average |
| OBP | On-base Percentage |
| SLG | Slugging Percentage |
| AB | At Bats |
| R | Runs |
| H | Hits |
| 1B | Singles |
| 2B | Doubles |
| 3B | Triples |
| HR | Home Runs |
| RBI | Runs Batted In |
| SH | Sacrifice Hits |
| SF | Sacrifice Flys |
| SB | Stolen Bases |
| CS | Caught Stealing |
| BB | Walks |
| IBB | Intentional Walks |
| HBP | Hit By Pitch |
| K | Strikeouts |
| GIDP | Ground Into Double Play |
| OPS | On-base + Slugging Percentage |
| TB | Total Bases |
| PO | Put Outs |
| A | Assists |
| E | Errors |
| FPCT | Fielding Percentage |
| XBH | Extra Base Hits |
| NSB | Net Stolen Bases |
| SB % | Stolen Base Percentage |
| CYC | Hitting for the Cycle |
| PA | Plate Appearances |
| SLAM | Grand Slam Home Runs |
| OFA | Outfield |
| | Assists |
| DPT | Double Plays Turned |
| CI | Catcher Interference |

Pitchers:

| | |
|---|---|
| APP | Appearances |
| GS | Games Started |
| ERA | Earned Run Average |
| WHIP | (Walks + Hits)/Innings Pitched |
| W | Wins |
| L | Losses |
| CG | Completed Games |
| SHO | Shutouts |
| SV | Saves |
| OUT | Outs |
| H | Hits |
| TBF | Total Batters Faced |
| R | Runs |
| ER | Earned Runs |
| HR | Home Runs |
| BB | Walks |
| IBB | Intentional Walks |
| HBP | Hit Batters |
| K | Strikeouts |
| WP | Wild Pitches |
| BLK | Balks |
| SB | Stolen Bases Allowed |
| GIDP | Batters Grounded Into Double Plays |
| SVOP | Save Chances |
| HLD | Holds |
| K/9 | Strikeouts per Nine Innings |
| K/BB | Strikeout to Walk Ratio |
| TB | Total Bases Allowed |
| IP | Innings Pitched |
| PC | Pitch Count |
| 2BA | Doubles Allowed |
| 3BA | Triples Allowed |
| RW | Relief Wins |
| RL | Relief Losses |
| PICK | Pickoffs |
| RAPP | Relief Appearances |
| WIN % | Winning Percentage |
| H/9 | Hits Per Nine Innings |
| BB/9 | Walks Per Nine Innings |
| NH | No Hitters |
| PG | Perfect Games |
| SV % | Save Percentage |
| QS | Quality Starts |
| BSV | Blown Saves |

Fantasy Basketball:

| GP | Games Played |
|---|---|
| GS | Games Started |
| MIN | Minutes Played |
| MPG | Minutes Played Per Game |
| FGA | Field Goals Attempted |
| FGM | Field Goals Made |
| FG % | Field Goals Percentage |
| FTA | Free Throws Attempted |
| FTM | Free Throws Made |
| FT % | Free Throws Percentage |
| 3PTA | 3-point Shots Attempted |
| 3PTM | 3-point Shots Made |
| 3PT % | 3-point Shots Percentage |
| PTS | Points Scored |
| OREB | Offensive Rebounds |
| DREB | Defensive Rebounds |
| REB | Total Rebounds |
| AST | Assists |
| ST | Steals |
| BLK | Blocked Shots |
| TO | Turnovers |
| A/T | Assist/Turnover Ratio |
| PF | Personal Fouls |
| DISQ | Times Fouled Out |
| TECH | Technical Fouls |
| EJCT | Ejections |
| FF | Flagrant Fouls |
| Abbreviation | What it Means |

Fantasy Hockey:
Forwards/Defensemen:

| | |
|---|---|
| G | Goals |
| A | Assists |
| P | Points |
| +/− | Plus/Minus |
| PIM | Penalty Minutes |
| PPG | Powerplay Goals |
| PPA | Powerplay Assists |
| PPP | Powerplay Points |
| SHG | Shorthanded Goals |
| SHA | Shorthanded Assists |
| SHP | Shorthanded Points |
| GWG | Game-Winning Goals |
| GTG | Game-Tying Goals |
| SOG | Shots on Goal |
| SH % | Shooting Percentage |
| FW | Faceoffs Won |
| FL | Faceoffs Lost |
| HIT | Hits |
| BLK | Blocks |

Goalies:

| | |
|---|---|
| GS | Games Started |
| W | Wins |
| L | Losses |
| GA | Goals Against |
| GAA | Goals Against Average |
| SA | Shots Against |
| SEC | Seconds Played |
| SV | Saves |
| SV % | Save Percentage |
| SHO | Shutouts |

Fantasy Football

| | |
|---|---|
| Passing | Passing Touchdowns |
| Passing | Interceptions |
| Passing | Passing Attempts |
| Passing | Completions |
| Passing | Incomplete Passes |
| Passing | Sacks |
| Passing | Passing Yards |
| Passing | Pick Sixes Thrown |
| Passing | 40+ Yard Completions |
| Passing | 40+ Yard Passing Touchdowns |
| Rushing | Rushing Touchdowns |
| Rushing | Rushing Attempts |
| Rushing | Rushing Yards |
| Rushing | 40+ Yard Rushing Attempts |
| Rushing | 40+ Yard Rushing Touchdowns |
| Receiving | Rushing Touchdowns |
| Receiving | Rushing Attempts |
| Receiving | Rushing Yards |
| Receiving | 40+ Yard Rushing Attempts |
| Receiving | 40+ Yard Rushing Touchdowns |
| Kick & Punt Returning | Return Touchdowns |
| Kick & Punt Returning | Return Yards |
| Miscellaneous | 2-Point Conversions |
| Miscellaneous | Fumbles |
| Miscellaneous | Fumbles Lost |
| Miscellaneous | Offensive Fumble Return TD |
| Kickers | Field Goals 0-19 Yards |
| Kickers | Field Goals 20-29 Yards |
| Kickers | Field Goals 30-39 Yards |
| Kickers | Field Goals 40-49 Yards |
| Kickers | Field Goals 50+ Yards |
| Kickers | Field Goals Missed 0-19 Yards |
| Kickers | Field Goals Missed 20-29 Yards |
| Kickers | Field Goals Missed 30-39 Yards |
| Kickers | Field Goals Missed 40-49 Yards |
| Kickers | Field Goals Missed 50+ Yards |
| Kickers | Point After Attempt Made |
| Kickers | Point After Attempt Missed |
| Defense/Special Teams | Points Allowed 0 points |
| Defense/Special Teams | Points Allowed 1-6 points |
| Defense/Special Teams | Points Allowed 7-13 points |
| Defense/Special Teams | Points Allowed 14-20 points |
| Defense/Special Teams | Points Allowed 21-27 points |
| Defense/Special Teams | Points Allowed 28-34 points |
| Defense/Special Teams | Points Allowed 35+ points |
| Defense/Special Teams | Sack |
| Defense/Special Teams | Interception |
| Defense/Special Teams | Fumble Recovery |
| Defense/Special Teams | Touchdown |
| Defense/Special Teams | Safety |
| Defense/Special Teams | Block Kick |
| Defense/Special Teams | Return Yards |
| Defense/Special Teams | Kickoff and Punt Return Touchdowns |
| Defense/Special Teams | 4th Down Stops |
| Defense/Special Teams | Tackles for Loss |
| Defense/Special Teams | Defensive Yards Allowed - Negative |
| Defense/Special Teams | Defensive Yards Allowed 0-99 |
| Defense/Special Teams | Defensive Yards Allowed 100- 199 |
| Defense/Special Teams | Defensive Yards Allowed 200-299 |
| Defense/Special Teams | Defensive Yards Allowed 300-399 |
| Defense/Special Teams | Defensive Yards Allowed 400-499 |
| Defense/Special Teams | Defensive Yards Allowed 500+ |
| Defense/Special Teams | Three and Outs Forced |

### Fantasy Golf

Individual golf scores are computed by taking the cumulative difference from the actual scores of each golfer (from their respective rounds) You would need to fill out a fantasy golf lineup so this game is not misconstrued as a prop bet. For instance, there may be fantasy golf tiers to which players you can procure. For the twenty golfers with the lowest projected scores, perhaps you are only allowed to obtain 3 of them. This can be said for each set of twenty, until the field is exhausted.
NASCAR: same scoring system as Golf. The cumulative difference of their projected finish(s). You would add the projected finishes of your drivers (a finite amount) and find the difference for their actual finish.

### NCAAB—“See Fantasy Basketball”

### NCAAF—“See Fantasy Football”

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

With respect to the appended claims, unless stated otherwise, the term “first” does not, by itself, require that there also be a “second”. Moreover, reference to only “a first” and “a second” does not exclude additional items (e.g., sensors). While the particular computer-based systems and methods described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

1. A method for conducting a game comprising:
generating a house fantasy team including predicted highest scoring players for each fantasy team position for a specified playing period and aggregating the predicted scores for said predicted highest scoring players for said specified playing period thereby forming a utopian score;
receiving assignments of a plurality of players for each fantasy team position from a first user forming a first user fantasy team for said specified playing period;
receiving real-world player scores for said specified playing period;
calculating a real-world first user fantasy team score by aggregating the real-world scores for said plurality of players for said specified playing period; and
awarding said first user if said real-world first user fantasy team score is greater than said utopian score.

2. A method for conducting a game comprising:
generating a house fantasy team including predicted highest scoring players for each fantasy team position for a specified playing period and aggregating the predicted scores for said predicted highest scoring players for said specified playing period thereby forming a utopian score;
receiving assignments of a plurality of players for each fantasy team position from a first user forming a first user fantasy team for said specified playing period;
receiving real-world player scores for said specified playing period;
calculating a real-world house fantasy team score by aggregating the real-world scores for said predicted highest scoring players for said specified playing period;
calculating a real-world first user fantasy team score by aggregating the real-world scores for said plurality of players for said specified playing period; and
awarding said first user if said real-world first user fantasy team score is greater than said real-world house fantasy team score.

3. A computer-based method for conducting a fantasy game comprising:
receiving assignments of a plurality of players from a first user forming a first user fantasy team, each player having one or more predicted playing metrics;
receiving, by way of a computer, real-world playing metrics from one or more real-world competitive events including one or more real-world playing metrics from said plurality of players of said first user fantasy team;
calculating award points for said first user based on the cumulative differences between said one or more real-world playing metrics and said one or more predicted playing metrics; and
awarding said first player based said calculated award points.

4. The method of claim 1, wherein said first user competes against one or more other users and wherein the user with the highest calculated award points wins the fantasy game.

5. The method of claim 1, wherein said first user competes against a specified number of other users and wherein the user with the highest calculated award points wins the fantasy game.

6. The method of claim 1, wherein said first user competes against a house user and the user with the highest award points wins the fantasy game.

7. The method of claim 1, wherein said awarding is performed after a predetermined timed interval.

8. The method of claim 1, wherein said awarding is performed after a predetermined number of real-world events.

9. The method of claim 1, wherein said fantasy game lasts one day, one week, one month, one season or one year.

10. The method of claim 1, wherein said players are assigned salary information and said first user is allocated fantasy money for forming said first user fantasy team within specified salary caps.

11. The method of claim 1, wherein said players include a finite number of players.

12. The method of claim 1, wherein said players are professional sports players, college players or Olympic players.

13. The method of claim 1, wherein said players are professional players selected from football, baseball, basketball, hockey, soccer, cricket, cycling, racing, tennis, or rugby.

14. The method of claim 1, wherein said players are professional players selected from NFL, MLB, NHL, NBA, PGA, or MLS.

15. The method of claim 1, wherein the players are baseball players and the one or more playing metrics including one or more metrics selected from the group consisting of: Hits, HR RBI, SB, BA, AVG, SLG %, OPS, OB %, W, WHIP, K/9, TB and IBB.

16. A computer based system capable of performing the method of claim 1 comprising a processor coupled to a memory, the memory having computer readable code, which when executed by the processor causes the computer system to perform the method.

17. The method of claim 1, performed using a computer-based algorithmic logic engine.
